(19) United States
(12) Patent Application Publication
(10) Pub. No.: US 2014/0283027 A1
(43) Pub. Date: Sep. 18, 2014

(54) Auditing User Actions in Treatment Related Files

(71) Applicant: CAREFUSION 303, INC., San Diego, CA (US)

(72) Inventors: Martin Orona, San Diego, CA (US); Aron Weiler, San Diego, CA (US)

(73) Assignee: CAREFUSION 303, INC., San Diego, CA (US)

(21) Appl. No.: 13/829,452

(22) Filed: Mar. 14, 2013

(51) Int. Cl. G06F 21/50

(52) U.S. Cl. CPC G06F 21/50
USPC 726/22

(57) ABSTRACT

The subject matter disclosed herein provides methods for monitoring treatment related files for the occurrence of audit events and logging these occurrences. In one aspect, there is provided a method that can include associating one or more audit events with one more files stored in a database. The files can be related to providing a treatment to a patient, and the audit events can include the viewing of the one or more files. The method can further include monitoring the one or more files for an occurrence of the one or more associated audit events, and adding a log entry to a log when the associated audit events occurs in the files. The log entry can identify the files in which the associated audit events occurs and an entity that initiated the audit event. Related apparatus, computer program products, systems, techniques and articles are also described.

### TECHNICAL FIELD

The subject matter described herein relates to the auditing of files that are used during the course of patient treatment and, more particularly, to the tracking of occurrences of designated events in these files.

### BACKGROUND

Healthcare providers maintain countless records throughout the course of business. These records memorialize important information relating to patient care and can include patient files, laboratory test results, data sets, and the like. Because the information in these records are relied upon during the course of treatment and are often of a sensitive nature, these records should be closely monitored to safeguard their contents.

This concern is especially relevant to the protection of confidential patient information. The Health Insurance Portability and Accountability Act (HIPAA) generally prohibits the public disclosure of confidential patient information. If, for example, a hospital employee unlawfully discloses a patient's medical history, the hospital can be found liable for violation of privacy laws.

This concern is also relevant to the operation of medical devices. Medical devices can be used to diagnose, prevent, and treat diseases and conditions in patients. In order to ensure proper operation of a medical device, the operational parameters on the device should reflect a hospital's best practice guidelines. Data sets, which contain device configurations, drug libraries, clinical advisories and other important information, can be pushed to medical devices to keep their operational parameters current. Modification or tampering of these data sets can result in improper operation of the medical device.

### SUMMARY

In some implementations, methods and apparatus, including computer program products, and systems are provided for the monitoring of treatment related files for the occurrence of audit events and the storing of these occurrences in a log.

In one aspect, one or more audit events are associated with one or more files stored in a database. The one or more files are related to providing a treatment to a patient, and the one or more audit events include at least viewing the one or more files. In addition, the one or more files are monitored for an occurrence of the one or more associated audit events. When the monitoring indicates an occurrence of one or more associated audit events, a log entry is added to a log. The log entry identifies at least the one or more files in which the one or more associated audit events occurs and an entity that initiated the audit event.

The above methods, apparatus, computer program products, and systems can, in some implementations, further include one or more of the following features.

The viewing can be automatically associated with the one or more files when the one or more files contains confidential patient information. The log entry can further include an identifier associated with the patient and a duration of time associated with the viewing. The one or more audit events can include modifying the one or more files, and the modifying can include adding to or deleting from the one or more files. The log entry can further identify changes to the one or more files that result from the modifying. The monitoring can be done continuously or at predetermined time intervals. The associating, the monitoring, and the adding can be implemented by at least one data processor forming part of at least one computing system.

In addition, one or more reports can be generated from the log entries in the log. These reports can be generated by receiving one or more search parameters for the one or more files. The one or more search parameters can identify a desired file, a desired patient, a desired audit event, a desired date or time for an occurrence of the desired audit event, and data characterizing an entity. The generating of these reports can further include extracting the log entries associated with the one or more search parameters and displaying the extracted log entries.

Computer program products are also described that comprise non-transitory computer readable media storing instructions, which when executed one or more data processor of one or more computing systems, causes at least one data processor to perform operations described herein. Similarly, computer systems are also described that can include one or more data processors and a memory coupled to the one or more data processors. The memory can temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages. For example, in some implementations, a file audit program can be used to monitor treatment related files for the occurrence of an audit event and to record these occurrences in a log. The occurrence of an audit event can indicate that a treatment related file has been manipulated. In addition, the current subject matter can allow a hospital administrator to generate reports from the information recorded in the log. These reports can be used to track the history of a desired file.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated herein and constitute a part of this specification, show certain aspects of the subject matter disclosed herein and, together with the description, help explain some of the principles associated with the subject matter disclosed herein. In the drawings,

FIG. 1 is a system diagram illustrating a computing landscape within a healthcare environment;

FIG. 2 illustrates two treatment related files;

FIG. 3 illustrates a properties window associated with a file;

FIG. 4 is a log that stores audit events; and

FIG. 5 is a flowchart for recording the occurrence of an audit event in a log.

Like reference symbols in the various drawings indicate like elements.

### DETAILED DESCRIPTION

The subject matter disclosed herein relates to the monitoring of treatment related files for the occurrence of audit events and the storing of these occurrences in a log. In some implementations, these files can be associated with various audit events. The occurrence of an audit event can signify that a treatment related file has been manipulated.

FIG. 1 is a system diagram illustrating a computing landscape 100 within a healthcare environment such as a hospital. Various devices and systems, both local to the healthcare environment and remote from the healthcare environment, can interact via at least one computing network 105. This computing network 105 can provide any form or medium of digital communication connectivity (i.e., wired or wireless) amongst the various devices and systems. Examples of communication networks include a local area network (“LAN”), a wide area network (“WAN”), and the Internet. In some cases, one or more of the various devices and systems can interact directly via peer-to-peer coupling (either via a hardwired connection or via a wireless protocol such as Bluetooth or WiFi). In addition, in some variations, one or more of the devices and systems communicate via a cellular data network.

In particular, aspects of the computing landscape 100 can be implemented in a computing system that includes a back-end component (e.g., as a data server 110), or that includes a middleware component (e.g., an application server 115), or that includes a front-end component (e.g., a client computer 120 having a graphical user interface or a Web browser through which a user can interact with an implementation of the subject matter described herein), or any combination of such back-end, middleware, or front-end components. A client 120 and servers 110 and 115 are generally remote from each other and typically interact through the communications network 105. The relationship of the clients 120 and servers 110, 115 arises by virtue of computer programs running on the respective computers and having a client-server relationship to each other. Clients 120 can be any of a variety of computing platforms that include local applications for providing various functionality within the healthcare environment. Example clients 120 include, but are not limited to, desktop computers, laptop computers, tablets, and other computers with touch-screen interfaces. The local applications can be self-contained in that they do not require network connectivity and/or they can interact with one or more of the servers 110, 115 (e.g., a web browser).

A variety of applications can be executed on the various devices and systems within the computing landscape such as electronic health record applications, medical device monitoring, operation, and maintenance applications, scheduling applications, billing applications and the like.

The network 105 can be coupled to one or more data storage systems 125. The data storage systems 125 can include databases providing physical data storage within the healthcare environment or within a dedicated facility. In addition, or in the alternative, the data storage systems 125 can include cloud-based systems providing remote storage of data in, for example, a multi-tenant computing environment. The data storage systems 125 can also comprise non-transitory computer readable media.

Mobile communications devices (MCDs) 130 can also form part of the computing landscape 100. The MCDs 130 can communicate directly via the network 105 and/or they can communicate with the network 105 via an intermediate network such as a cellular data network 135. Various types of communication protocols can be used by the MCDs 130 including, for example, messaging protocols such as SMS and MMS.

Various types of medical devices 140 can be used as part of the computing landscape 100. These medical devices 140 can comprise, unless otherwise specified, any type of device or system with a communications interface that characterizes one or more physiological measurements of a patient and/or that characterize treatment of a patient. In some cases, the medical devices 140 communicate via peer to peer wired or wireless communications with another medical device 140 (as opposed to communicating with the network 105). For example, the medical device 140 can comprise a bedside vital signs monitor that is connected to other medical devices 140, namely a wireless pulse oximeter and to a wired blood pressure monitor. One or more operational parameters of the medical devices 140 can be locally controlled by a clinician, controlled via a clinician via the network 105, and/or they can be controlled by one or more of a server 110 and/or 115, a client 120, a MCD 130, and/or another medical device 140.

The computing landscape 100 can provide various types of functionality as can be required within a healthcare environment such as a hospital. For example, a pharmacy can initiate a prescription via one of the client computers 120. This prescription can be stored in the data storage 125 and/or pushed out to other clients 120, an MCD 130, and/or one or more of the medical devices 140. In addition, the medical devices 140 can provide data characterizing one or more physiological measurements of a patient and/or treatment of a patient (e.g., medical device 140 can be an infusion management system, etc.). The data generated by the medical devices 140 can be communicated to other medical devices 140, the servers 110 and 115, the clients 120, the MCDs 130, and/or stored in the data storage systems 125.

With regard to the computing landscape of FIG. 1, data storage 125 can store one or more files related to the treatment of a patient. These files can contain different types of information including, for example, patient records, configuration files for medical devices, and the like.

FIG. 2 illustrates two types of treatment related files 205 and 250 that can be stored in data storage 125. File 205 can contain information relating to a patient and can be identified by a file identification number 210. File 205 can include the patient's name 215 and an area 220 that describes the patient's contact information, insurance information, and the like. Area 220 can also include treatment related information including, for example, the patient's medical history, treatment plan, diagnosis, laboratory test reports, and the like. The information in area 220 can be protected by federal privacy rules under HIPAA.

File 250 can contain information relating to a data set. A data set can include a hospital's best practice guidelines for drug administration and can include profile drug libraries, clinical advisories, medical device configurations, and channel label libraries. The information in a data set can be loaded onto a medical device to define various operational parameters associated with the device. File 250 can be identified by a file identification number 255 and can include the name of the data set 260 being described. Area 265 can include notes regarding data set 260.

The integrity of files 205 and 250 can be compromised during the course of treatment. This can occur when an unauthorized individual obtains access to a file containing confidential information (such as confidential patient information protected under HIPAA) or tampers with the contents of a file (such as the configuration parameters for a medical device in a data set). In order to identify these breaches, a file audit program can be used to monitor and track the manipulation of these files.

A server, such as application server 115, can be configured to run a file audit program. Using this program, application server 115 can monitor any of the files stored in data storage 125, such as files 205 and 250, for the occurrence of one or more audit events.

An audit event can represent a particular action that is tracked for auditing purposes. These actions can be designated by a hospital administrator and can include, for example, the accessing or viewing of a file, the modification of a file, and the like. Modifying a file can include adding, deleting, or otherwise changing the contents of the file.

Tracking who has accessed or viewed a file can be useful if, for example, an individual unlawfully discloses confidential patient information. Tracking this information can be useful in identifying the perpetrator. Similarly, tracking how a file is modified can be useful if, for example, a modified data set results in improper operation of a medical device. Recording the changes to the data set can be useful in identifying the cause of the medical device's malfunction.

An administrator can associate the files stored in data storage 125 with one or more audit events by modifying each file's properties using the file audit program. FIG. 3 illustrates a properties window 300 associated with a selected file, such as file 205 or file 250. Properties window 300 can display information relating to the selected file including, for example, the location that the file was saved to 305, the size of the file 310, and any audit events 320 associated with the file. Audit events 320 can include any of the audit events described above. With regard to FIG. 3, an administrator can associate one or more of audit events 320A, 320B, or 320C with the selected file by placing a check mark next to the desired audit event. In some implementations, an administrator can choose not to associate any audit events with the selected file. In the implementation of FIG. 3, audit events 320A and 320C can be associated with the selected file. Other attributes can be included in window 300 including, for example, the presence of security settings, when the file was created, and the like.

In some implementations, one or more audit events can be automatically associated with a file depending on the contents of the file. For example, an administrator can automatically associate all files having confidential patient information, such as file 205, with a file viewing event. Referring to FIG. 3, this automatic association can be made based on the information in field 315 which can indicate whether a file includes confidential patient information. If a check mark appears in field 315, then the file includes confidential patient information, and the audit program can automatically associate the file with a file viewing event. Other variations are possible including, for example, automatically associating files containing data sets with a file modification event and the like.

Application server 115 can monitor each file in data storage 125 for the occurrence of an audit event that is associated with the file. Application server 115 can be configured to continuously monitor the files for an audit event or at predetermined time intervals (e.g., every thirty seconds, every two minutes, etc.). When an audit event occurs, application server 115 can record the occurrence of the audit event in log 400 illustrated in FIG. 4. For example, if file 205 is associated with a file viewing event, and a user views the contents of file 205, then application server 115 can add a log entry to log 400 with the occurrence of this file viewing event. Log 400 can be stored in data storage 125.

Log 400 can have multiple log entries. For each log entry, log 400 can store the identification number of the file associated with the audit event in column 405, the identity of a patient associated with the audit event, if applicable, in column 407, a description of the audit event in column 410, when the audit event occurs in column 415, and the identity of an entity initiating the audit event (labeled as an initiator) in column 420. In this regard, the entity can include a specifically identified individual, a group of individuals, a role for an individual, a company, and the like.

The description in column 410 can specify the audit event type (e.g., a file viewing event, a file modification event, etc.). Additional information can be provided in column 410 depending on the audit event type. For example, if log entry 430 represents a file viewing event, then column 410 can also specify how long the file was viewed, whether this information was printed or saved to another location, and the like. In another example, if log entry 435 represents a data set modification event, then column 410 can also specify the additions, deletions, and changes that were made to the file.

Reports can be generated from the information stored in log 400. A hospital administrator can use these reports to trace the history of a particular file. This information can be useful in identifying when a particular file is manipulated and the nature of the manipulation. For example, if a hospital administrator learns that a patient's information has been leaked to the public, then the administrator can generate a report from log 400 that includes log entries for all files relating to the patient. The administrator can identify all individuals who have viewed the patient's files by filtering the results for a file viewing event.

In order to generate a report, a hospital administrator can enter one or more search parameters into application server 115. These search parameters can be used to filter the information in log 400 using any combination of criteria. Search parameters can include, for example, the identity of a desired document, the name or patient ID of a desired patient, a desired audit event, a desired date and/or time for an occurrence of the audit event, and/or the identity of a person suspected of causing the audit event.

Application server 115 can search log 400 for log entries having any of the received search parameters. For example, application server 115 can search the values in column 405 for the identity of a desired document. Similarly, application server 115 can search the values in columns 407, 410, 415, and 420 for the other search parameters described above. If a value in log 400 matches a search parameter, then application server 115 can extract the log entry associated with the matched value and can display the extracted log entry to a user in a report. Reports can be presented in any document format including, for example, a table, a document, a presentation file, and the like.

FIG. 5 illustrates a flowchart 500 for recording the occurrence of an audit event in a log. At 505, a user can associate one or more audit events with a file stored in a database. These files can be related to the providing of treatment to a patient. In some implementations, a user can manually associate an audit event with a file using the file audit program. In other implementations, the file audit program can automatically associate an audit event with a file. Automatic association can occur if, for example, a file contains confidential patient information. In some implementations, the audit event can correspond to the viewing of a file.

At 510, the files in the database can be monitored for the occurrence of an associated audit event. In some implementations, the file audit program can continuously monitor the files for the occurrence of an audit event or at predetermined time intervals.

At 515, a log entry can be added to a log when an audit event associated with a particular file occurs with respect to the file. The log entry can identify various parameters associated with the occurrence of the audit event including, for example, the affected file's identity (either by name or equivalent identifier) as well as the person who caused the occurrence of the audit event. In some implementations, the log entry can also identify when the audit event occurred and, if applicable, the affected patient's identity (either by name or equivalent identifier).

One or more aspects or features of the subject matter described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A method comprising:
associating one or more audit events with one more files stored in a database, the one or more files related to providing a treatment to a patient, and the one or more audit events including at least viewing the one or more files;
monitoring the one or more files for an occurrence of the one or more associated audit events; and
adding a log entry to a log when the one or more associated audit events occurs in the one or more files, the log entry identifying at least the one or more files in which the one or more associated audit events occurs and an entity that initiated the audit event.

2. The method of claim 1, wherein the viewing is automatically associated with the one or more files when the one or more files contains confidential patient information.

3. The method of claim 1, wherein the log entry further includes an identifier associated with the patient and a duration of time associated with the viewing.

4. The method of claim 1, wherein the one or more audit events includes modifying the one or more files, the modifying including adding to or deleting from the one or more files.

5. The method of claim 4, wherein the log entry further identifies changes to the one or more files that result from the modifying.

6. The method of claim 1, further comprising:
generating one or more reports from the log entries in the log, the generating including
receiving one or more search parameters for the one or more files, the one or more search parameters identifying a desired file, a desired patient, a desired audit event, a desired date or time for an occurrence of the desired audit event, and data characterizing an entity;
extracting the log entries associated with the one or more search parameters; and
displaying the extracted log entries.

7. The method of claim 1, wherein the monitoring is done continuously or at predetermined time intervals.

8. The method of claim 1, wherein the associating, the monitoring, and the adding are implemented by at least one data processor forming part of at least one computing system.

9. A non-transitory computer-readable medium containing instructions to configure a processor to perform operations comprising:
associating one or more audit events with one more files stored in a database, the one or more files related to providing a treatment to a patient, and the one or more audit events including at least viewing the one or more files;
monitoring the one or more files for an occurrence of the one or more associated audit events; and
adding a log entry to a log when the one or more associated audit events occurs in the one or more files, the log entry identifying at least the one or more files in which the one or more associated audit events occurs and an entity that initiated the audit event.

10. The non-transitory computer-readable medium of claim 9, wherein the viewing is automatically associated with the one or more files when the one or more files contains confidential patient information.

11. The non-transitory computer-readable medium of claim 9, wherein the log entry further includes an identifier associated with the patient and a duration of time associated with the viewing.

12. The non-transitory computer-readable medium of claim 9, wherein the one or more audit events includes modifying the one or more files, the modifying including adding to or deleting from the one or more files.

13. The non-transitory computer-readable medium of claim 12, wherein the log entry further identifies changes to the one or more files that result from the modifying.

14. The non-transitory computer-readable medium of claim 9, further comprising:
generating one or more reports from the log entries in the log, the generating including
receiving one or more search parameters for the one or more files, the one or more search parameters identifying a desired file, a desired patient, a desired audit event, a desired date or time for an occurrence of the desired audit event, and data characterizing an entity;
extracting the log entries associated with the one or more search parameters; and
displaying the extracted log entries.

15. The non-transitory computer-readable medium of claim 9, wherein the monitoring is done continuously or at predetermined time intervals.

16. A system comprising:
a processor; and
a memory, wherein the processor and the memory are configured to perform operations comprising:
associating one or more audit events with one more files stored in a database, the one or more files related to providing a treatment to a patient, and the one or more audit events including at least viewing the one or more files;
monitoring the one or more files for an occurrence of the one or more associated audit events; and
adding a log entry to a log when the one or more associated audit events occurs in the one or more files, the log entry identifying at least the one or more files in which the one or more associated audit events occurs and an entity that initiated the audit event.

17. The system of claim 16, wherein the viewing is automatically associated with the one or more files when the one or more files contains confidential patient information.

18. The system of claim 16, wherein the one or more audit events includes modifying the one or more files, the modifying including adding to or deleting from the one or more files.

19. The system of claim 16, the operations further comprising:
generating one or more reports from the log entries in the log, the generating including
receiving one or more search parameters for the one or more files, the one or more search parameters identifying a desired file, a desired patient, a desired audit event, a desired date or time for an occurrence of the desired audit event, and data characterizing an entity;
extracting the log entries associated with the one or more search parameters; and
displaying the extracted log entries.
